(19) United States
(12) Patent Application Publication
(10) Pub. No.: US 2011/0211498 A1
(43) Pub. Date: Sep. 1, 2011

(54) Method For Communication Via A Half-Duplex Radio Channel In A Radio Network

(75) Inventors: Dieter Hofmann, Hausen (DE); Peter Steinmill, Schwarzenbruck (DE)

(73) Assignee: Siemens AG, Muenchen (DE)

(21) Appl. No.: 13/001,464

(22) PCT Filed: Jun. 25, 2009
(86) PCT No.: PCT/EP2009/057936

§ 371 Date: May 20, 2011

(30) Foreign Application Priority Data
Jun. 27, 2008 (EP) 08011715.3

(51) Int. Cl. H04W 4/00

(52) U.S. Cl. 370/277

(57) ABSTRACT

A communication method for a radio network, comprising at least two subscribers, wherein a radio channel is used in both directions among the subscribers, but only consecutively in the one and then in the other direction, i.e., not simultaneously in both directions. In accordance with the invention, the subscribers are each specified transmission times in a time period, at which either subscriber is permitted to send a user telegram to the other subscriber, where a detection signal is embedded at the beginning of each user telegram, or such a detection signal precedes the user telegram, and the embedded detection signal is used to notify the receiving subscriber of the assignment of the radio channel.

### CROSS-REFERENCE TO RELATED APPLICATIONS

This is a U.S. national stage of International Application No. PCT/EP2009/057936, filed on 25 Jun. 2009. The entire content of which application is incorporated herein by reference.

### BACKGROUND OF THE INVENTION

1. Field of the Invention

The invention relates to radio communications and, more particularly, to a communication method for a radio network, having at least two subscribers, where although a radio channel is used in both directions between the subscribers, the communication is always only successively in one direction and then in the other direction, i.e., the communication is not simultaneously in both directions.

2. Description of the Art

In various communication applications for data interchange, there is only a single radio channel available. In this case, half-duplex methods are used. Such half-duplex methods involve messages being sent only successively in one or the other direction. In conventional systems, the simultaneous use of a radio link in both directions results in collisions and must therefore be avoided. In order to prevent such collisions, “polling” is used, which involves a cyclic request being made. For example, a master sends a slave in a communication network a request in one direction, and the slave then responds by sending an available user message in the other direction. If there are no user data available, this unavailability of user data can be communicated in the response message. The conventional half-duplex method involves times of appropriate length being reserved for the requests and response messages, which in the case of many requests results in excessively long reaction times.

### SUMMARY OF THE INVENTION

It is therefore an object of the invention to improve a communication method such that the shortest possible reaction times are achieved.

This and other objects and advantages are in accordance with the invention are achieved by a method in which the subscribers have respective transmission times stipulated for them in a time pattern, at which transmission times a subscriber is permitted to send the respective other subscriber a user message, where the start of each user message has an embedded identification signal, or such an identification signal is a prefix to the user message, and where the identification signal is used to notify the receiving subscriber of the busy condition of the radio link. The use of the identification signal makes it possible to achieve higher-performance information transmission on a single-channel radio link than the previously known half-duplex method.

In a particularly advantageous embodiment of the invention, a subscriber transmits a user message at the admissible transmission time only if an identification signal has not been received from the other subscriber.

In another advantageous embodiment, a time interval from one transmission time in the time pattern which is associated with a subscriber for the transmission of a user message to the next transmission time in the time pattern which is associated with the respective other subscriber for the transmission of a user message is determined essentially by the transit time for the identification signal on the radio link between the two subscribers. This embodiment allows particularly short reaction times.

In advantageous embodiment, the transmission times stipulated for one subscriber for the transmission of a user message are in sync with the transmission times which are stipulated for the respective other subscriber for the transmission of a user message.

In a further advantageous embodiment of, the transmission times for the transmission of a user message are stipulated for the two subscribers by a respective time ruler with a time pattern which is determined by the time interval.

In yet a further advantageous embodiment, the identification signal is at least partially bit-encoded for safe transmission of the identification signal.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention is explained in more detail below with reference to a drawing, in which:

FIG. 1 shows a block diagram of a test station for vehicle diagnosis using the communication method according to the invention via a radio channel;

FIG. 2 shows a time scale with a time pattern for the communication method according to the invention; and

FIG. 3 is a flow chart of the method in accordance with an embodiment of the invention.

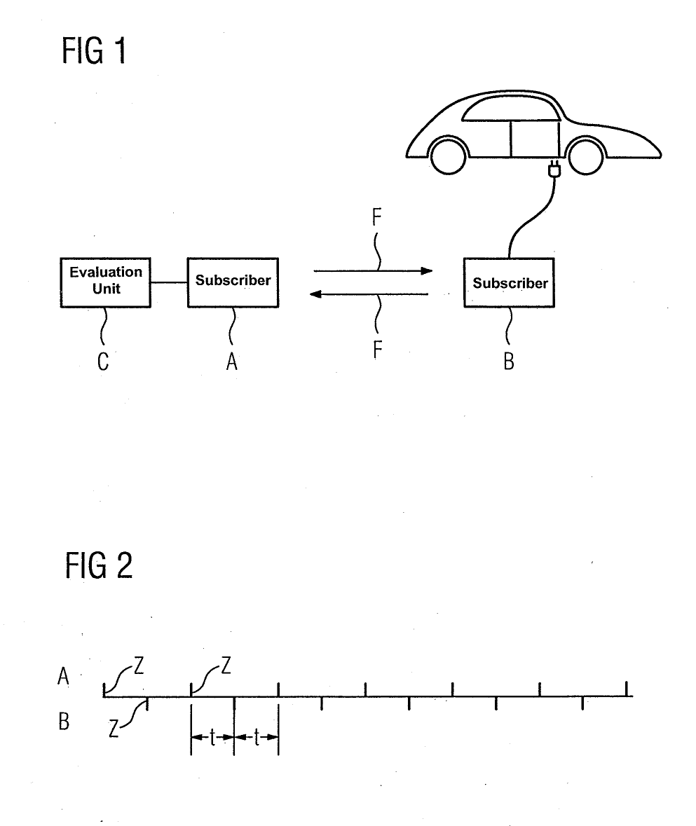

FIG. 1 shows a radio channel F between two subscribers A and B. The radio channel F can be used only successively in one direction, and then in the other direction to prevent collisions during the communication. In the present exemplary embodiment, the radio channel F is used for vehicle diagnosis. The subscriber A is therefore connected to an evaluation unit C, and the subscriber B is connected to a vehicle, such as by a diagnosis connector. The subscriber B records the vehicle data and sends them over the radio channel F to the subscriber A, which forwards them to the evaluation unit C for evaluation. Following evaluation of the vehicle data in the evaluation unit C, the subscriber B can receive a stipulation to change a setting on the vehicle via the radio channel F.

The communication method in accordance with the invention, which can be used in this context, allows both subscribers A and B to send user messages with equal rights to the respective other subscriber B or A without long reaction times. To this end, both subscribers A and B have respective transmission times stipulated for them in a time pattern, at which transmission times a subscriber A or B is permitted to send the respective other subscriber B or A a user message. In accordance with the method of the invention, the transmission times are starting times for sending the user messages. In order to avoid collisions in this case, the communication method in accordance with the invention ensures that, at the respective transmission time of the subscriber A or B, the radio channel F is not currently busy with the respective other subscriber B or A. The information about the busy condition is provided by an identification signal which is embedded at the start of the user message or is prefixed to the user message. A subscriber A or B is permitted to send a user message at a transmission time which is associated with said subscriber if an identification signal has not been received from the respective other subscriber B or A at this time, which simultaneously indicates that the radio channel F is currently not busy and is free for sending a user message. The transit time for the identification signal over the radio channel F from one subscriber to the other essentially determines the time interval t from a transmission time Z in the time pattern which is associated with a subscriber A or B for the transmission of a user message to the next transmission time Z in the time pattern. This time pattern with the time intervals t is shown on a time scale in FIG. 2. The identification signal is advantageously at least partially bit-encoded and allows rapid identification of the busy state.

The transmission times (Z) for transmission of a user message which are stipulated for one subscriber (A or B) are in sync with the transmission time (Z) which are stipulated for the respective other subscriber (B or A) for transmission of a user message.

This is achieved by the use of two time scales with the same time pattern as shown in FIG. 2, for example, where one subscriber (A or B) stipulates the time scale and the other subscriber (B or A) matches its time scale to the stipulation. The subscriber stipulating the time ruler has a master function only in this regard. Otherwise, both subscribers have equal rights in the communication method described above.

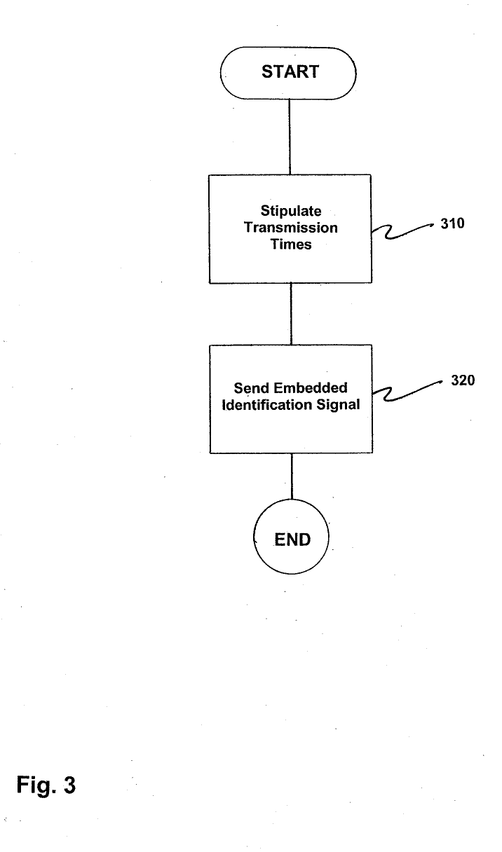

FIG. 3 is a flow chart of a communication method for a radio network, having at least two subscribers, where a radio channel is used in both directions between the subscribers, always only successively in one direction and then in another direction, but not simultaneously in both directions. The method comprises stipulating respective transmission times in a time pattern for the subscribers at which transmission times one of the subscribers is permitted to send another of the subscribers a user message, as indicated in step 310. Here, the start of each user message has an embedded identification signal, or the embedded identification signal is a prefix of the user message. One of the subscribers sends a user message with the embedded identification signal for receipt by the another subscriber to notify the another subscriber of the busy condition of the radio channel, as indicated in step 320.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1.-12. (canceled)

13. A communication method for a radio network, having at least two subscribers, wherein a radio channel being used in both directions between the subscribers, always only successively in one direction and then in another direction, and not simultaneously in both directions, the method comprising:
stipulating respective transmission times in a time pattern for the subscribers at which transmission times one of the subscribers is permitted to send another of the subscribers a user message, a start of each user message having an embedded identification signal, or the embedded identification signal being a prefix of the user message; and
sending, by the one of the subscribers, a user message with the embedded identification signal for receipt by the another subscriber to notify the another subscriber of the busy condition of the radio channel.

14. The communication method as claimed in claim 13, wherein one of the subscribers sends the user message at an admissible transmission time only if the embedded identification signal has not been received from the another subscriber.

15. The communication method as claimed in claim 13, wherein a time interval from one transmission time in the time pattern associated with the one of the subscribers for the transmission of the user message to a next transmission time in the time pattern associated with the another subscriber for the transmission of the user message is determined essentially by a transit time for the embedded identification signal on the radio channel between the at least two subscribers.

16. The communication method as claimed in claim 14, wherein a time interval from one transmission time in the time pattern associated with the one of the subscribers for the transmission of the user message to a next transmission time in the time pattern associated with the another subscriber for the transmission of the user message is determined essentially by a transit time for the embedded identification signal on the radio channel between the at least two subscribers.

17. The communication method as claimed in claim 13, wherein the respective transmission times stipulated for the one of the subscribers for the transmission of the user message are in sync with the transmission times stipulated for the another subscriber for the transmission of the user message.

18. The communication method as claimed in claim 13, wherein the transmission times for the transmission of the user message are stipulated for the at least two subscribers by a respective time scale having a time pattern determined by a time interval.

19. The communication method as claimed in claim 13, wherein the embedded identification signal is at least partially bit-encoded.

20. The communication method as claimed claim 13, wherein the one of the subscribers stipulates a time scale and the another subscriber matches its time scale to the stipulation.

21. The communication method as claimed in claim 13, wherein the stipulated respective transmission times are starting points for transmission of user messages.

22. The communication method as claimed in claim 13, wherein the method is implemented to perform vehicle diagnosis.

23. The communication method as claimed in claim 22, wherein the one of the subscribers is connected to a vehicle to record vehicle data and sends the another subscriber the recorded vehicle data for evaluation in an evaluation unit.

24. The communication method as claimed in claim 22, wherein the one of the subscribers connected to the vehicle receives, following evaluation of the vehicle data in the evaluation unit, a stipulation to change a setting on the vehicle from the another subscriber over the radio channel.

25. The communication method as claimed in claim 24, wherein the stipulation to change the setting on the vehicle is displayed on a display.
